(19) United States
(12) Patent Application Publication
(10) Pub. No.: US 2013/0082897 A1
(43) Pub. Date: Apr. 4, 2013

(54) UNIPOLAR, BIPOLAR AND HYBRID MIMO ANTENNAE

(71) Applicants: Ruopeng Liu, Shenzhen (CN); Yangyang Zhang, Shenzhen (CN); Chunlin Ji, Shenzhen (CN)

(72) Inventors: Ruopeng Liu, Shenzhen (CN); Yangyang Zhang, Shenzhen (CN); Chunlin Ji, Shenzhen (CN)

(21) Appl. No.: 13/521,446

(22) PCT Filed: Sep. 29, 2011
(86) PCT No.: PCT/CN11/80354

§ 371 Date: Jul. 11, 2012

(30) Foreign Application Priority Data
Mar. 14, 2011 (CN) 201110062200.6

(51) Int. Cl. H01Q 21/00

(52) U.S. Cl. CPC H01Q 21/00
USPC 343/893

(57) ABSTRACT

The present disclosure provides a unipolar MIMO antenna, which consists of a plurality of unipolar RF antennae. Each of the unipolar RF antennae comprises a metal sheet and a feeder line. The metal sheet is enchased with a metal microstructure thereon, and the feeder line and the metal sheet are connected in a signal communicative manner. The unipolar MIMO antenna of the present disclosure breaks through the framework of the conventional antenna design and eliminates the complex design of the impedance matching network to ensure miniaturization of the antenna. Thereby, the antenna can be used in a wireless apparatus having a small size, a high transmission efficiency and a high isolation degree among antennae and can satisfy the requirement of a low power consumption in the design of modern communication systems. Additionally, the present disclosure further provides a bipolar MIMO antenna and a hybrid MIMO antenna.

### FIELD OF THE INVENTION

The present disclosure generally relates to the technical field of wireless communication, and more particularly, to a unipolar multiple-input multiple-output (MIMO) antenna, a bipolar MIMO antenna and a hybrid MIMO antenna.

### BACKGROUND OF THE INVENTION

With advancement of the semiconductor manufacturing processes, requirements on the integration level of modern electronic systems become increasingly higher, and correspondingly, miniaturization of components has become a problem of great concern in the whole industry. However, unlike integrated circuit (IC) chips that advance following the Moore's Law, radio frequency (RF) modules which are known as another kind of important components in the electronic systems are very difficult to be miniaturized. An RF module mainly comprises a mixer, a power amplifier, a filter, an RF signal transmission component, a matching network and an antenna as key components thereof. The antenna acts as a transmitting unit and a receiving unit for RF signals, and the operation performances thereof have a direct influence on the operation performance of the overall electronic system. However, some important indicators of the antenna such as the size, the bandwidth and the gain are restricted by the basic physical principles (e.g., the gain limit under the limitation of a fixed size, and the bandwidth limit). The limits of these indicators make miniaturization of the antenna much more difficult than miniaturization of other components; and furthermore, due to complexity of analysis of the electromagnetic field of the RF component, even approximately reaching these limits represents a great technical challenge.

Meanwhile, because MIMO systems can significantly increase the information throughput and the transmission distance without the need of increasing the bandwidth or increasing the total transmission power loss, MIMO technologies have received much attention in recent years. Besides, the core concept of the MIMO technologies is to improve the utilization factor of the frequency spectrum by virtue of the spatial freedom provided by multiple transmit (TX) antennae and multiple receive (RX) antennae, so how to design MIMO antennae having a high isolation degree and high radiating performances under the limitation of a limited size of the wireless apparatus (e.g., a wireless access apparatus, a wireless router or a wireless mobile terminal) has become a problem that hinders widespread use of the wireless transmission technologies such as the 3^{rd} Generation (3G) mobile communication system, the 4^{th} Generation (4G) mobile communication system and the high-speed Wireless Local Area Network (WLAN). The communication antennae of conventional terminals are designed primarily on the basis of the electric monopole or dipole radiating principles, an example of which is the most common planar inverted F antenna (PIFA). For a conventional antenna, the radiating operation frequency thereof is positively correlated with the size of the antenna directly, and the bandwidth is positively correlated with the area of the antenna, so the antenna usually has to be designed to have a physical length of a half wavelength. This makes it difficult to implement the conventional antenna technologies under the limitations of a limited size of the wireless apparatus.

Besides, in some more complex wireless apparatuses, the antenna needs to operate in a multi-mode condition, and this requires use of an additional impedance matching network design at the upstream of the infeed antenna. However, the additional impedance matching network adds to the complexity in design of the feeder line of the wireless apparatuses and increases the area of the RF system and, meanwhile, the impedance matching network also leads to a considerable energy loss. This makes it difficult to satisfy the requirement of a low power consumption in the design of modern wireless communication systems.

### SUMMARY OF THE INVENTION

In view of the shortcomings of the prior art that it is difficult to implement the conventional antenna technologies under the limitations of a limited size of the wireless apparatus and it is difficult to satisfy the requirement of a low power consumption in the design of modern communication systems, the technical problem to be solved by the present disclosure is to provide a multiple-input multiple-output (MIMO) antenna, which breaks through the framework of the conventional antenna design and eliminates the complex design of the impedance matching network to ensure miniaturization of the antenna. Thereby, the antenna can be used in a wireless apparatus having a limited size and features a high utilization factor of the radiating area and a high interference immunity.

The present disclosure provides a unipolar MIMO antenna consisting of a plurality of unipolar radio frequency (RF) antennae. Each of the unipolar RF antennae comprises a metal sheet and a feeder line, the metal sheet is enchased with a metal microstructure thereon, and the feeder line and the metal sheet are connected in a signal communicative manner.

According to a preferred embodiment of the present disclosure, each of the unipolar RF antennae further comprises a short-circuit point for connection with the feeder line and the metal sheet.

According to a preferred embodiment of the present disclosure, the metal microstructures include a complementary split ring resonator structure, a complementary spiral structure, a split spiral ring structure, a dual split spiral ring structure, a complementary meander-line structure and structures obtained through derivation, combination or arraying of the aforesaid structures.

According to a preferred embodiment of the present disclosure, the metal microstructures are the same for each of the unipolar RF antennae in the unipolar MIMO antenna.

According to a preferred embodiment of the present disclosure, the metal microstructures of at least two of the unipolar RF antennae in the unipolar MIMO antenna are different from each other.

According to a preferred embodiment of the present disclosure, each of the unipolar RF antennae further comprises a medium for disposing the metal sheet and the feeder line thereon.

According to a preferred embodiment of the present disclosure, the medium is one of air, ceramic, an epoxy resin substrate and a polytetrafluoroethylene (PTFE) substrate.

The present disclosure provides a bipolar MIMO antenna consisting of a plurality of bipolar RF antennae. Each of the bipolar RF antennae comprises two metal sheets, a feeder line and a grounding unit for providing a common ground potential, the two metal sheets are both enchased with a metal microstructure thereon, and the two metal sheets are connected with the feeder line in a signal communicative manner.

According to a preferred embodiment of the present disclosure, the metal microstructures include a complementary split ring resonator structure, a complementary spiral structure, a split spiral ring structure, a dual split spiral ring structure, a complementary meander-line structure and structures obtained through derivation, combination or arraying of the aforesaid structures.

According to a preferred embodiment of the present disclosure, the metal microstructures are the same for each of the bipolar RF antennae in the bipolar MIMO antenna.

According to a preferred embodiment of the present disclosure, the metal microstructures of at least two of the bipolar RF antennae in the bipolar MIMO antenna are different from each other.

According to a preferred embodiment of the present disclosure, both the metal sheets are formed with a metallized through-hole, and the two metal sheets are shorted together through the metallized through-holes.

According to a preferred embodiment of the present disclosure, each of the bipolar RF antennae further comprises a medium disposed between the two metal sheets, with the two metal sheets being disposed above and below the medium respectively.

According to a preferred embodiment of the present disclosure, the medium is one of air, ceramic, an epoxy resin substrate and a polytetrafluoroethylene (PTFE) substrate.

The present disclosure provides a hybrid MIMO antenna, which comprises at least one unipolar RF antenna and at least one bipolar RF antenna. Each of the at least one unipolar RF antenna comprises a metal sheet, a feeder line and a short-circuit point for connection with the feeder line and the metal sheet, and the metal sheet is enchased with metal microstructures thereon; and each of the at least one bipolar RF antenna comprises two flat metal sheets that are parallel with each other, a feeder line and a grounding unit, both the metal sheets are provided with short-circuit points for connection with the feeder line and the grounding unit, and both the metal sheets are enchased with the metal microstructure thereon.

According to a preferred embodiment of the present disclosure, the metal microstructures include a complementary split ring resonator structure, a complementary spiral structure, a split spiral ring structure, a dual split spiral ring structure, a complementary meander-line structure and structures obtained through derivation, combination or arraying of the aforesaid structures.

According to a preferred embodiment of the present disclosure, the metal microstructures are the same for each of the at least one unipolar RF antenna in the hybrid MIMO antenna.

According to a preferred embodiment of the present disclosure, the metal microstructures of at least two of the at least one unipolar RF antenna in the hybrid MIMO antenna are different from each other.

According to a preferred embodiment of the present disclosure, the metal microstructures are the same for each of the at least one bipolar RF antenna in the hybrid MIMO antenna.

According to a preferred embodiment of the present disclosure, the metal microstructures of at least two of the at least one bipolar RF antenna in the hybrid MIMO antenna are different from each other.

The aforesaid three solutions have the same technical effects as follows: through the design of the structure of the antenna, the complex design of the impedance matching network is eliminated to ensure miniaturization of the antenna. Thereby, the antenna can be used in a wireless apparatus having a small and limited size, and small antennae in the overall MIMO antenna have an increased isolation degree therebetween and thus are easy to be integrated together.

### BRIEF DESCRIPTION OF THE DRAWINGS

To describe the technical solutions of embodiments of the present disclosure more clearly, the attached drawings necessary for description of the embodiments will be introduced briefly hereinbelow. Obviously, these attached drawings only illustrate some of the embodiments of the present disclosure, and those of ordinary skill in the art can further obtain other attached drawings according to these attached drawings without making inventive efforts. In the attached drawings:

FIG. 1 is a schematic view illustrating a structure of a unipolar MIMO antenna system consisting of a plurality of unipolar RF antennae;

FIG. 2 is a schematic view illustrating a structure of a preferred embodiment of the unipolar RF antennae according to the present disclosure;

FIG. 3 is a simulation diagram illustrating an operating frequency of the first antenna of the unipolar MIMO antenna according to the present disclosure;

FIG. 4 is a simulation diagram illustrating an isolation degree between the first antenna and the second antenna of the unipolar MIMO antenna according to the present disclosure;

FIG. 5 is a simulation diagram illustrating an isolation degree between the first antenna and the third antenna of the unipolar MIMO antenna according to the present disclosure;

FIG. 6 is a schematic view illustrating a structure of a bipolar MIMO antenna system consisting of a plurality of bipolar RF antennae;

FIG. 7 is a schematic view illustrating a structure of a preferred embodiment of the bipolar RF antennae according to the present disclosure;

FIG. 8 is a simulation diagram illustrating an operating frequency of—the fourth antenna of the bipolar MIMO antenna according to the present disclosure;

FIG. 9 is a simulation diagram illustrating an isolation degree between the fourth antenna—and the fifth antenna—of the bipolar MIMO antenna according to the present disclosure;

FIG. 10 is a simulation diagram illustrating an isolation degree between the fourth antenna and the sixth antenna—of the bipolar MIMO antenna according to the present disclosure; and

FIG. 11 is a schematic view illustrating a structure of a hybrid MIMO antenna system according to the present disclosure.

### DETAILED DESCRIPTION OF THE INVENTION

Hereinbelow, the present disclosure will be further described with reference to the to attached drawings and embodiments thereof.

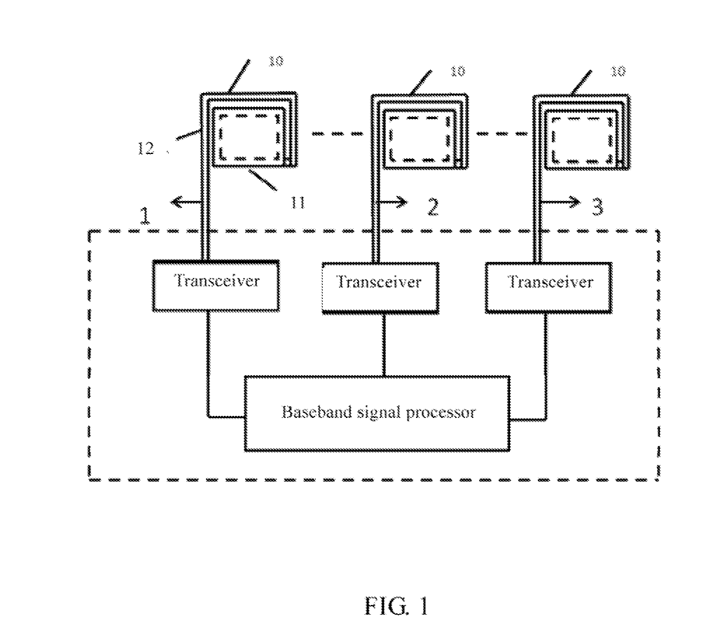

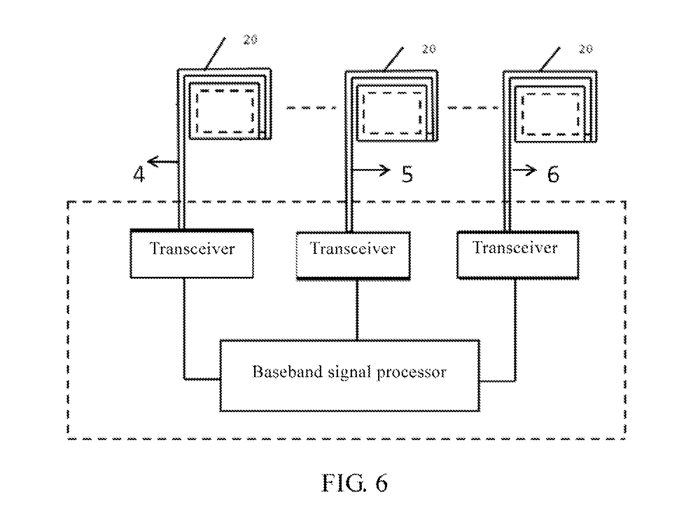

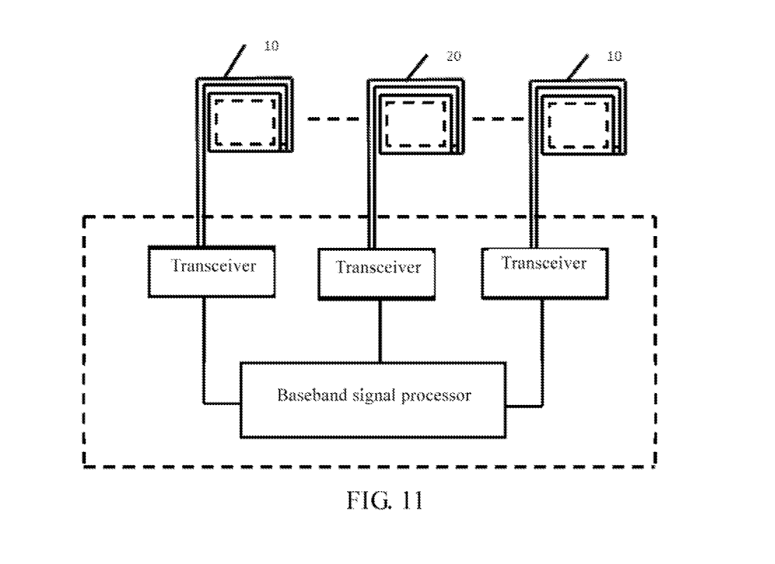

As shown in FIG. 1, FIG. 6 and FIG. 11, the present disclosure provides three forms of MIMO antennae, namely, a unipolar MIMO antenna, a bipolar MIMO antenna and a hybrid MIMO antenna.

The unipolar MIMO antenna of the present disclosure consists of a plurality of unipolar RF antennae 10, the bipolar MIMO antenna of the present disclosure consists of a plurality of bipolar RF antennae 20, and the hybrid MIMO antenna of the present disclosure consists of at least one unipolar RF antenna 10 and at least one bipolar RF antenna 20. The term “MIMO” used herein refers to “multiple-input multiple-output”. That is, all individual antennae of an MIMO antenna transmit simultaneously and receive simultaneously.

Hereinbelow, the present disclosure will be introduced in detail with reference to three embodiments respectively.

### Embodiment I

As shown in FIG. 1, the unipolar MIMO antenna in this embodiment consists of a plurality of unipolar RF antennae, each of which comprises a metal sheet 11 and a feeder line 12. The feeder line 12 is fed into the metal sheet 11 in a signal coupling manner. Metal microstructures of the unipolar RF antennae constituting the unipolar MIMO antenna may be all the same as each other or be different from each other. Each of the unipolar RF antennae is connected to one transceiver, and all of the transceivers are connected to one baseband signal processor.

A medium for disposing the metal sheet and the feeder line thereon in the present disclosure may be air, ceramic or a medium substrate. A short-circuit point for the feeder line and the metal microstructure may be located at any position on the metal microstructure. For the unipolar MIMO antenna of this embodiment, the operating frequency thereof may be tuned by adjusting the feed-in coupling manner of the feeder line, the topology microstructure and the size of the metal sheet, the length of a lead of the feeder line, and the position of the short-circuit point for the feeder line and the metal microstructure.

The man-made electromagnetic material is an equivalent special material produced from metal microstructures, the performance of which is determined by the subwavelength metal microstructures directly. In the resonance waveband, the man-made electromagnetic material usually exhibits a highly dispersive characteristic; i.e., the impedance, the capacitance and the inductance, the equivalent dielectric constant and the magnetic permeability of the man-made electromagnetic material vary greatly with the frequency. Therefore, the basic characteristics of the medium in contact with the metal sheet can be altered by using the man-made electromagnetic material so that the metal sheet and the medium in contact therewith equivalently form a special electromagnetic material that is highly dispersive, thus achieving a novel antenna with rich radiation characteristics.

By virtue of the characteristics of the man-made electromagnetic material and by having a metal microstructure enchased on the metal sheet in this embodiment, the metal sheet and the medium in contact therewith jointly form an electromagnetic material whose equivalent dielectric constant varies according to the Lorentz material resonance model, thereby achieving the purpose of changing the radiation characteristics of the antenna.

In this embodiment, the antenna may be manufactured in various ways so long as the design principle of the present disclosure is followed. The most common method is to adopt manufacturing methods of various printed circuit boards (PCBs), and both the manufacturing method of a PCB formed with metallized through-holes and that of a PCB covered by copper on both surfaces thereof can satisfy the processing requirement of the present disclosure. Apart from this, other processing means may also be used depending on actual requirements, for example, the conductive silver paste & ink processing for the radio frequency identification (RFID), the flexible PCB processing for various deformable components, the ferrite sheet antenna processing, and the processing means of the ferrite sheet in combination with the PCB. The processing means of the ferrite sheet in combination with the PCB means that the chip microstructure portion is processed by an accurate processing process for the PCB and other auxiliary portions are processed by using ferrite sheets.

Secondly, the short-circuit point may be located at any position on the metal sheet. How the feeder line is fed in has no influence on the operation principle of the present disclosure, but has an influence on the specific radiation characteristics of the antenna.

Meanwhile, because the primary performances of the present disclosure are all associated with the topology of the metal microstructure and the design of the chip portion, the lead of the feeder line has a relatively small influence on the radiation frequency of the antenna. On the basis of this feature, RF-chip small antennae may be flexibly arranged at any position in a wireless system, and this can reduce the complexity in installation and testing.

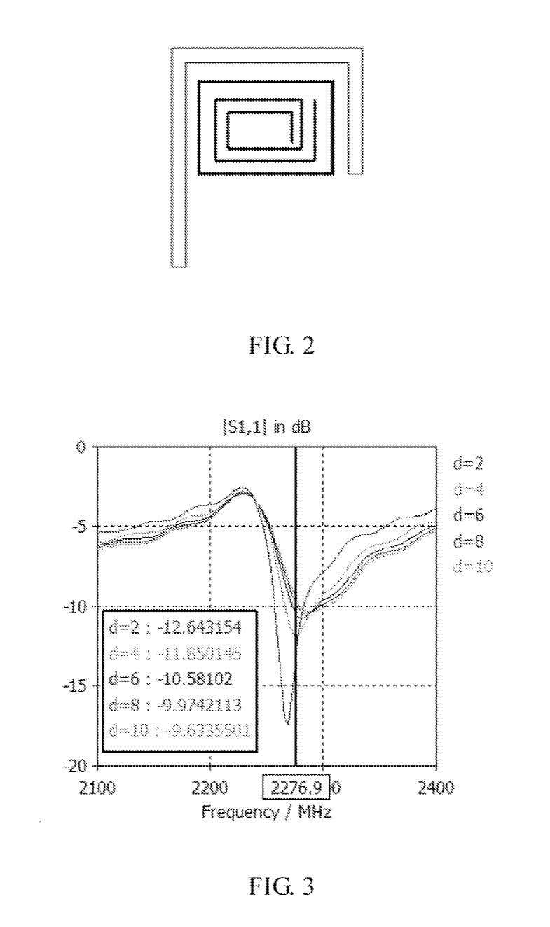

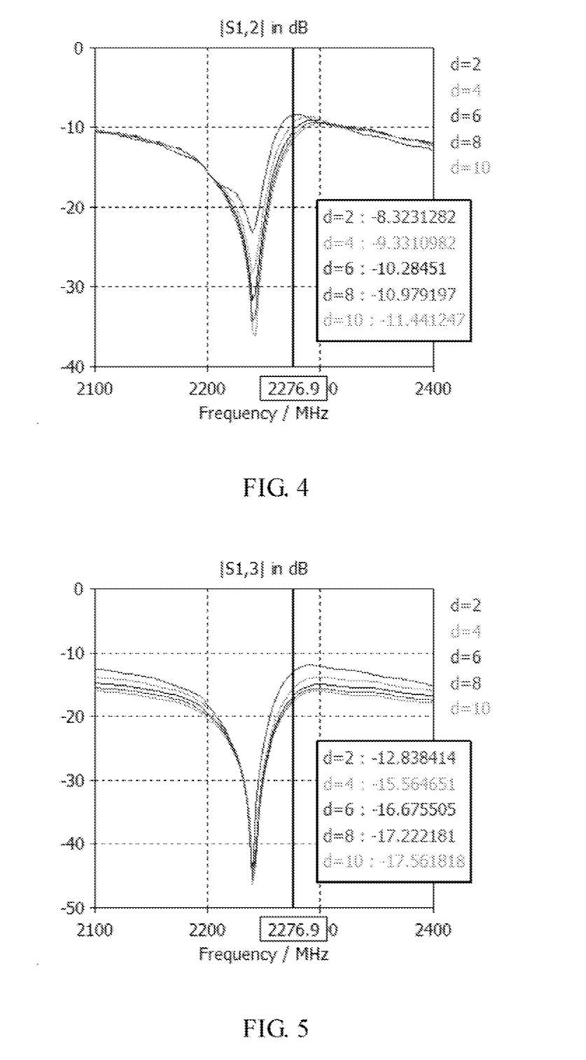

FIG. 2 illustrates a unipolar RF antenna having a complementary spiral metal microstructure enchased on a metal sheet 11 thereof in the MIMO RF-chip antenna according to the present disclosure. FIG. 3 is a simulation testing diagram illustrating an operating frequency of the first antenna when unipolar RF antennae as shown in FIG. 2 are installed in the unipolar MIMO antenna; and meanwhile, the second antenna and the third antenna have the same operating frequency. FIG. 4 is a simulation testing diagram illustrating an isolation degree between the first antenna and the second antenna when unipolar RF antennae as shown in FIG. 2 are installed in the unipolar MIMO antenna. This diagram represents that the receiving and transmitting testing is carried out between the first antenna and the second antenna. The parameter S21 in FIG. 4 represents that the first antenna transmits a signal and the second antenna receives the signal; and the isolation degree between the first antenna and the second antenna is measured according to the simulation testing result of the parameter S21. Meanwhile, the distance between the two antennae is adjusted to obtain a schematic simulation diagram illustrating the isolation degree between the two antennae that varies with the distance. FIG. 5 is a simulation testing diagram illustrating an isolation degree between the first antenna and the third antenna when unipolar RF antennae as shown in FIG. 2 are installed in the unipolar MIMO antenna. This diagram represents that the receiving and transmitting testing is carried out between the first antenna and the third antenna. The parameter S31 in FIG. 5 represents that the first antenna transmits a signal and the third antenna receives the signal; and the isolation degree between the first antenna and the third antenna is measured according to the simulation testing result of the parameter S31. Meanwhile, the distance between the two antennae is adjusted to obtain a schematic simulation diagram illustrating the isolation degree between the two antennae that varies with the distance. As can be seen from FIG. 3, a port 1 has an operating frequency of 2276.9 MHz. If the port 1 is a signal input end, a port 2 is a signal receiving end and both the port 1 and the port 2 have an operating frequency of 2276.9 MHz, then the signal receiving capability of the port 2 varies with a distance d between antennae connected to the port 1 and the port 2. Specifically, when d=2 mm, dB=−8.3231282; when d=4 mm, dB=−9.3310982; when d=6 mm, dB=−10.28451; when d=8 mm, dB=−10.979197; and when d=10 mm, dB=−11.441247. On the other hand, if the port I is a signal input end, a port 3 is a signal receiving end and both the port 1 and the port 3 have an operating frequency of 2276.9 MHz, then the signal receiving capability of the port 3 varies with a distance d between antennae connected to the port 1 and the port 3. Specifically, when d=2 mm, dB=−12.838414; when d=4 mm, dB=−15.564651; when d=6 mm, dB=−16.675505; when d=8 mm, dB=−17.222181; and when d=10 mm, dB=−17.561818. As can be seen from this, in the unipolar MIMO antenna with a limited space of the present disclosure, two adjacent antennae have little interference therebetween, and the interference between the two antennae decreases as the distance increases. As shown by the simulation testing, the MIMO multiple-antenna technology of the present disclosure features a very high isolation degree.

### Embodiment II

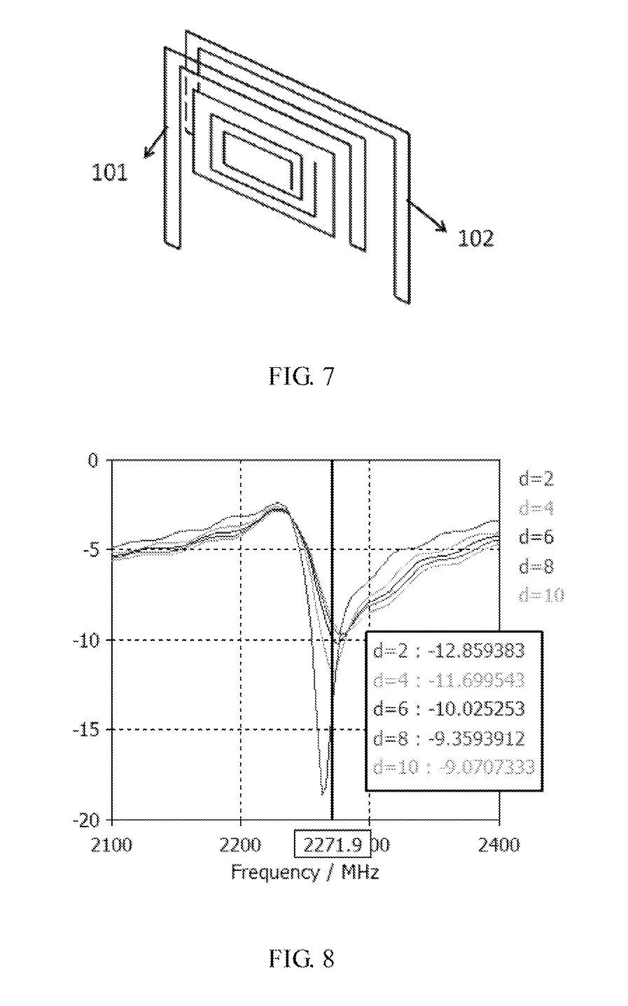

As shown in FIG. 6 and FIG. 7, in this embodiment, the bipolar MIMO antenna consists of a plurality of bipolar RF antennae 20, and each of the bipolar RF antennae 20 comprises a feeder line 101, a grounding unit 102, and two metal sheets having a topology structure. The two metal sheets are disposed in parallel with each other. The feeder line 101 feeds a baseband signal into one of the metal sheets, and the grounding unit 102 is connected to the other of the metal sheets. Moreover, the two metal sheets may be each formed with a metallized through-hole, which is used to short the metal sheets together. Metal microstructures of the bipolar RF antennae constituting the bipolar MIMO antenna may be all the same as each other or be different from each other. Each of the bipolar RF antennae is connected to one transceiver, and all of the transceivers are connected to one baseband signal processor.

The feeder line and the grounding unit are viewed as two pins of an RF-chip small antenna, and have a standard feed impedance of 50 ohm; however, the feeder line may be fed in and the grounding unit be connected through either capacitive coupling or inductive coupling. The topology structures and sizes of the upper and the lower metal sheets may be the same as each other, but may also be different from each other to result in a hybrid structure design without altering the basic radiation principle. In this case, a medium between the two metal sheets is a physical packing medium (the material of the medium may be chosen arbitrarily, and may generally be air, ceramic or a medium substrate). The upper and the lower metal sheets may be shorted together through the metallized through-holes. When the two metal sheets are shorted, the radiation parameters of the antenna will change accordingly. Additionally, a short-circuit point for the feeder line and the grounding unit may be located at any position.

The MIMO RF-chip array antenna of this embodiment may be tuned by adjusting the feed-in coupling manner of the feeder line, the grounding manner of the grounding unit, the metal microstructures and the sizes of the upper and the lower metal sheets, the positions of the metallized through-holes of the upper and the lower metal sheets, and the positions of the short-circuit points for the feeder line and the grounding unit and the upper and the lower metal sheets.

In this embodiment, by virtue of the characteristics of the man-made electromagnetic material and by having a metal microstructure enchased on the upper and the lower metal sheets, an electromagnetic material whose dielectric constant varies according to the Lorentz material resonance model is equivalently filled between the metal sheets, thereby achieving the purpose of changing the radiation characteristics of the antenna.

In this embodiment, the antenna may be manufactured in various ways so long as the design principle of the present disclosure is followed. The most common method is to adopt manufacturing methods of various PCBs, and both the manufacturing method of a PCB formed with metallized through-holes and that of a PCB covered by copper on both surfaces thereof can satisfy the processing requirement of the present disclosure.

Because the primary characteristics of the bipolar MIMO antenna are all associated with the design of the metal microstructure, the leads of the feeder line and the grounding unit have a relatively small influence on the radiation frequency of the antenna. On the basis of this feature, the complexity in installation and testing of the bipolar MIMO antenna is reduced significantly.

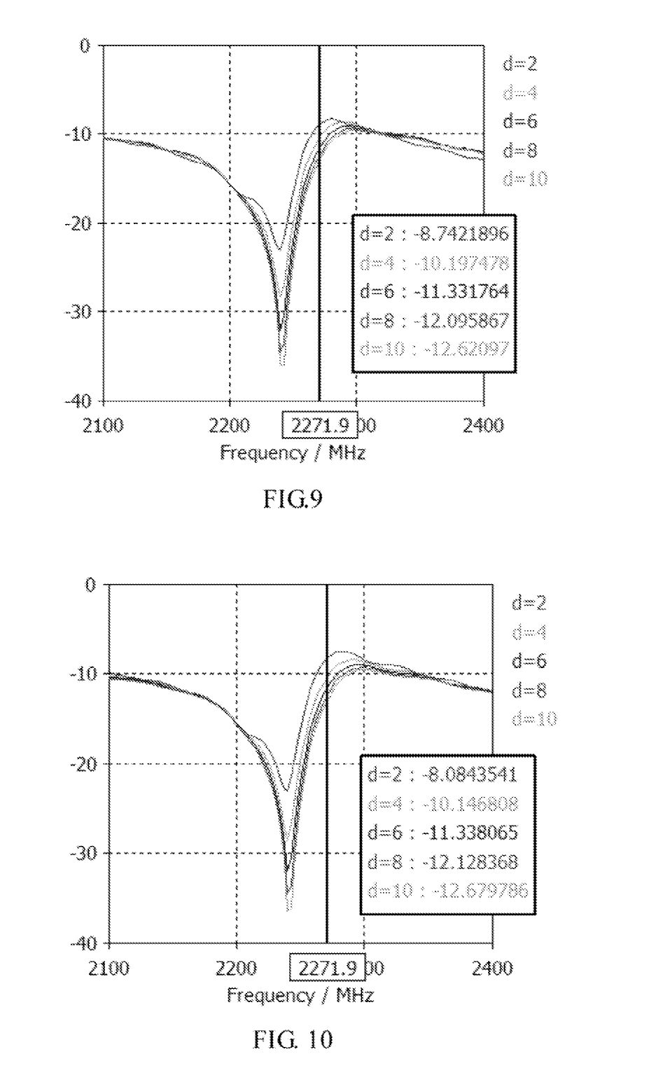

FIG. 7 illustrates a bipolar RF antenna having complementary spiral metal microstructures enchased on metal sheets thereof in the MIMO RF chip antenna according to the present disclosure. FIG. 8 is a simulation testing diagram illustrating an operating frequency of the fourth antenna when bipolar RF antennae as shown in FIG. 7 are installed in the bipolar MIMO antenna; and meanwhile, the fifth antenna and the sixth antenna have the same operating frequency. FIG. 9 is a simulation testing diagram illustrating an isolation degree between the fourth antenna and the fifth antenna when bipolar RF antennae as shown in FIG. 7 are installed in the bipolar MIMO antenna. This diagram represents that the receiving and transmitting testing is carried out between the fourth antenna and the fifth antenna. The parameter in FIG. 9 represents that the fourth antenna transmits a signal and the fifth antenna receives the signal; and the isolation degree between the fourth antenna and the fifth antenna is measured according to the simulation result shown in FIG. 9. Meanwhile, the distance between the two antennae is adjusted to obtain a schematic simulation diagram illustrating the isolation degree between the two antennae that varies with the distance. FIG. 10 is a simulation testing diagram illustrating an isolation degree between the fourth antenna and the sixth antenna when bipolar RF antennae as shown in FIG. 7 are installed in the bipolar MEMO antenna. This diagram represents that the receiving and transmitting testing is carried out between the fourth antenna and the sixth antenna. The parameter in FIG. 10 represents that the fourth antenna transmits a signal and the sixth antenna receives the signal; and the isolation degree between the fourth antenna and the sixth antenna is measured according to the simulation testing result. Meanwhile, the distance between the two antennae is adjusted to obtain a schematic simulation diagram illustrating the isolation degree between the two antennae that varies with the distance. As can be seen from FIG. 8, a port 4 has an operating frequency of 2271.9 MHz. If the port 4 is a signal input end, a port 5 is a signal receiving end and both the port 4 and the port 5 have an operating frequency of 2271.9 MHz, then the signal receiving capability of the port 5 varies with a distance d between antennae connected to the port 4 and the port 5. Specifically, when d=2 mm, dB=−8.7421896; when d=4 mm, dB=−10.197478; when d=6 mm, dB=−11.331764; when d=8 mm, dB=−12.095867; and when d=10 mm, dB=−12.62097. If the port 4 is a signal input end, a port 6 is a signal receiving end and both the port 4 and the port 6 have an operating frequency of 2271.9 MHz, then the signal receiving capability of the port 6 varies with a distance d between antennae connected to the port 4 and the port 6. Specifically, when d=2 mm, dB=−8.0843541; when d=4 mm, dB=−10.146808; when d=6 mm, dB=−11.338065; when d=8 mm, dB=−12.128368; and when d=10 mm, dB=−12.679786. As can be seen from this, in the bipolar MIMO antenna with a limited space of the present disclosure, antennae have little interference therebetween, and the interference between two antennae decreases as the distance d increases. As shown by the simulation testing, the MIMO multiple-antenna technology of the present disclosure features a very high isolation degree.

### Embodiment III

As shown in FIG. 11, in this embodiment, the hybrid MIMO antenna consists of at least one unipolar RF antenna 10 and at least one bipolar RF antenna 20. Metal microstructures of the RF antennae constituting the hybrid MIMO antenna may be all the same as each other or be different from each other. Each of the RF antennae is connected to one transceiver, and all of the transceivers are connected to one baseband signal processor.

The characteristics of the at least one unipolar RF antenna and the at least one bipolar RF antenna in this embodiment are identical to those of the RF antennae in the embodiment I and the embodiment II, and thus will not be further described herein.

Additionally, the structure of the metal microstructures is not limited to what shown in FIG. 2 and FIG. 7, but may also be of other structures such as a split ring resonator structure, a complementary spiral structure, a split spiral ring structure, a dual split spiral ring structure, a complementary meander-line structure and structures obtained through derivation, combination or arraying of the aforesaid structures. The aforesaid metal microstructures are existing microstructures that are described in detail in China Patent Publication No. CN201490337, and thus will not be further described herein.

The embodiments of the present disclosure have been described above with reference to the attached drawings; however, the present disclosure is not limited to the aforesaid embodiments, and these embodiments are only illustrative but are not intended to limit the present disclosure. Those of ordinary skill in the art may further devise many other implementations according to the teachings of the present disclosure without departing from the spirits and the scope claimed in the claims of the present disclosure, and all of the implementations shall fall within the scope of the present disclosure.

What is claimed is:

1. A unipolar multiple-input multiple-output (MIMO) antenna, comprising a plurality of unipolar radio frequency (RF) antennae, wherein each of the unipolar RF antennae comprises a metal sheet and a feeder line, the metal sheet is enchased with a metal microstructure thereon, and the feeder line and the metal sheet are connected in a signal communicative manner.

2. The unipolar MIMO antenna of claim 1, wherein each of the unipolar RF antennae further comprises a short-circuit point for connection with the feeder line and the metal sheet.

3. The unipolar MIMO antenna of claim 1, wherein the metal microstructures include a complementary split ring resonator structure, a complementary spiral structure, a split spiral ring structure, a dual split spiral ring structure, a complementary meander-line structure and metal microstructures obtained through derivation, combination or arraying of the aforesaid structures.

4. The unipolar MIMO antenna of claim 3, wherein the metal microstructures are the same for each of the unipolar RF antennae in the unipolar MIMO antenna.

5. The unipolar MIMO antenna of claim 3, wherein the metal microstructures of at least two of the unipolar RF antennae in the unipolar MIMO antenna are different from each other.

6. The unipolar MIMO antenna of claim 1, wherein each of the unipolar RF antennae further comprises a medium for disposing the metal sheet and the feeder line thereon.

7. The unipolar MIMO antenna of claim 6, wherein the medium is one of air, ceramic, an epoxy resin substrate and a polytetrafluoroethylene (PTFE) substrate.

8. A bipolar MIMO antenna, comprising a plurality of bipolar RF antennae, wherein each of the bipolar RF antennae comprises two metal sheets, a feeder line and a grounding unit for providing a common ground potential, the two metal sheets are both enchased with a metal microstructure thereon, and the two metal sheets are connected with the feeder line in a signal communicative manner.

9. The bipolar MIMO antenna of claim 8, wherein the metal microstructures include a complementary split ring resonator structure, a complementary spiral structure, a split spiral ring structure, a dual split spiral ring structure, a complementary meander-line structure and metal microstructures obtained through derivation, combination or arraying of the aforesaid structures.

10. The bipolar MIMO antenna of claim 9, wherein the metal microstructures are the same for each of the bipolar RF antennae in the bipolar MIMO antenna.

11. The bipolar MIMO antenna of claim 9, wherein the metal microstructures of at least two of the bipolar RF antennae in the bipolar MIMO antenna are different from each other.

12. The bipolar MIMO antenna of claim 8, wherein both the metal sheets are formed with a metallized through-hole, and the two metal sheets are shorted together through the metallized through-holes.

13. The bipolar MIMO antenna of claim 8, wherein each of the bipolar RF antennae further comprises a medium disposed between the two metal sheets, with the two metal sheets being disposed above and below the medium respectively.

14. The bipolar MIMO antenna of claim 13, wherein. the medium is one of air, ceramic, an epoxy resin substrate and a polytetrafluoroethylene (PTFE) substrate.

15. A hybrid MIMO antenna, comprising at least one unipolar RF antenna and at least one bipolar RF antenna, wherein:
each of the at least one unipolar RF antenna comprises a metal sheet, a feeder line and a short-circuit point for connection with the feeder line and the metal sheet, and the metal sheet is enchased with a metal microstructure thereon; and
each of the at least one bipolar RF antenna comprises two metal sheets, a feeder line and a grounding unit, both the metal sheets are provided with short-circuit points for connection with the feeder line and the grounding unit, and both the metal sheets are enchased with the metal microstructure thereon.

16. The hybrid MIMO antenna of claim 15, wherein the metal microstructures include a complementary split ring resonator structure, a complementary spiral structure, a split spiral ring structure, a dual split spiral ring structure, a complementary meander-line structure and metal microstructures obtained through derivation, combination or arraying of the aforesaid structures.

17. The hybrid MIMO antenna of claim 16, wherein the metal microstructures are the same for each of the at least one unipolar RF antenna in the hybrid MIMO antenna.

18. The hybrid MIMO antenna of claim 16, wherein the metal microstructures of at least two of the at least one unipolar RF antenna in the hybrid MIMO antenna are different from each other.

19. The hybrid MIMO antenna of claim 16, wherein the metal microstructures are the same for each of the at least one bipolar RF antenna in the hybrid MIMO antenna.

20. The hybrid MIMO antenna of claim 16, wherein the metal microstructures of at least two of the at least one bipolar RF antenna in the hybrid MIMO antenna are different from each other.
